(19) United States
(12) Patent Application Publication
(10) Pub. No.: US 2009/0096718 A1
(43) Pub. Date: Apr. 16, 2009

(54) PLASMA DISPLAY DEVICE

(75) Inventors: Fumito Kusama, Osaka (JP); Tosikazu Nagaki, Osaka (JP); Masaaki Kuranuki, Kyoto (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/293,365

(22) PCT Filed: Jan. 9, 2008
(86) PCT No.: PCT/JP2008/050090

§ 371 Date: Sep. 17, 2008

(30) Foreign Application Priority Data
Jan. 12, 2007 (JP) 2007-004158

(51) Int. Cl. G09G 3/28

(52) U.S. Cl. 345/60

(57) ABSTRACT

The plasma display device has the following structure: a panel having a plurality of discharge cells; an electrode-dedicated power supply for generating voltage to be applied to any one of the electrodes disposed on the panel; a driving-waveform generator that has a switching element for outputting voltage of the electrode-dedicated power supply so as to generate a waveform of driving voltage for driving the electrodes; a switch controller for controlling the switching element; a controller-dedicated power supply for supplying the switch controller with electric power; and an auxiliary power supply that generates a voltage lower than that of the controller-dedicated power supply by reducing voltage of the electrode-dedicated power supply so as to supply the switch controller with electric power.

### FIELD OF THE INVENTION

The present invention relates to a plasma display device as an image display device using a plasma display panel.

### BACKGROUND OF THE INVENTION

Alternating-current surface discharge type plasma display panel, which has dominance in plasma display panels (hereinafter simply referred to as a panel), has a plurality of discharge cells formed between a front plate and a rear plate oppositely disposed with each other.

On the front plate, a plurality of display electrodes, each of which is formed of a pair of a scan electrode and a sustain electrode, is arranged in parallel with each other. On the other hand, on the rear plate, a plurality of data electrodes is formed in parallel with each other. The front plate and the rear plate are faced with each other and sealed together in a manner that the display electrodes and the data electrodes intersect with each other. A discharge space, which is formed between the front plate and the rear plate, is filled with discharge gas. Discharge cells are formed at intersections of the display electrodes and the data electrodes.

As a driving method of a panel, a subfield method is well known. In the method, one TV field is divided into a plurality of subfields and combination of light-emitting subfields provides gradation images for display.

Each of the subfields has an initializing period, an address period and a sustain period. An initializing discharge occurs in the initializing period, by which wall charges required for succeeding address operations are formed on each electrode. In the address period, scan pulses as address voltage are applied to the scan electrodes and address pulses are selectively applied to the data electrodes, so that an address discharge occurs selectively in the discharge cells and wall charges are formed as a result of the discharge. In the sustain period, sustain pulses are applied to the display electrodes formed of scan electrodes and the sustain electrodes. The application of the sustain pulses causes a sustain discharge in the discharge cells where an address discharge occurred. Through the discharge operations above, the discharge cells having the sustain discharge emit light, by which an image appears.

To drive the panel, the driving circuit applies various waveforms of driving voltage having different values to each of the electrodes. Besides, not only the current required for discharge operations but also the current for charging/discharging an inter-electrode capacity have to be kept in stable condition. The driving circuit therefore needs many power supplies and switching elements. In particular, scan electrode driving circuit has a need for applying complex waveforms of driving voltage because a differently shaped waveform of the driving voltage has to be applied to each of the scan electrodes. Therefore, the scan electrode driving circuit has a complicated circuit structure with difficulty in determining properly timed switching operations. In particular, when the power switch is turned off, each voltage generated in the power supply circuit decreases at a speed that depends on the capacity of the power supply and the amount of load. To cope with the situation above, manufacturers incorporate a wide range of schemes into the structure so as to encourage a safe decrease in voltage with no residual voltage in each power supply. For instance, patent reference 1 discloses an improved circuit structure that detects a voltage of a power supply having a fast decrease at power-off and accelerates, with the use of a thyristor, a slow decrease of a voltage of a power supply. As another suggestion, patent reference 2 discloses a plasma display device with a structure capable of discharging residual voltage by changing the driving method of the sustain electrodes or the scan electrodes according to decrease in voltage detected at power-off.

According to the conventional methods, however, the structure needs additional special circuits or means as follows: a circuit for detecting decrease in voltage at power-off, a circuit for forcefully decreasing voltage of a power supply circuit, and a means for changing the driving method of the driving circuit.

Patent reference 1: Japanese Unexamined Patent Application Publication No. H07-210112
Patent reference 2: Japanese Unexamined Patent Application Publication No. 2002-132210

### SUMMARY OF THE INVENTION

To address the problem above, the present invention provides a plasma display device that allows the driving circuit to have a safe completion of operations of panel driving with no worry about abnormal operations at power-off of the device.

The plasma display device has the following structure:
a plasma display panel having a plurality of discharge cells, each of the discharge cell being formed of at least a scan electrode, a sustain electrode and a data electrode;
an electrode-dedicated power supply for generating voltage to be applied to any one of the scan electrode, the sustain electrode and the data electrode;
a driving-waveform generator that has a switching element for outputting voltage of the power supply and generates a waveform of driving voltage for driving the electrodes;
a switch controller for controlling the switching element;
a controller-dedicated power supply for supplying the switch controller with electric power; and
an auxiliary power supply that generates a voltage lower than that of the controller-dedicated power supply by reducing voltage of the electrode-dedicated power supply and supplies the controller with electric power.

### BRIEF DESCRIPTION OF THE DRAWINGS

FIG. 1 is an exploded perspective view showing the structure of a panel in accordance with an exemplary embodiment of the present invention.

FIG. 2 shows an electrode layout of the panel of the embodiment.

FIG. 3 is a circuit block diagram of a plasma display device of the embodiment.

FIG. 4 shows a detailed diagram of the scan electrode driving circuit of the embodiment.

FIG. 5 shows waveforms of driving voltage to be applied to each electrode of the embodiment.

FIG. 6 shows a detailed circuit block diagram of the scan pulse output circuit of the embodiment.

FIG. 7 shows control operations of the output controller of the embodiment.

FIG. 8 is a circuit diagram of the scan pulse output circuit and the power supply for supplying power to the output circuit of the embodiment.

FIG. 9A shows an example of the auxiliary power supply of the embodiment.

FIG. 9B shows another example of the auxiliary power supply of the embodiment.

FIG. 10 shows the workings of the auxiliary power supply of the embodiment.

### REFERENCE MARKS IN THE DRAWINGS

10 panel

22 scan electrode

23 sustain electrode

24 display electrode

32 data electrode

41 image signal processing circuit

42 data electrode driving circuit

43 scan electrode driving circuit

44 sustain electrode driving circuit

45 timing signal generating circuit

46 power supply circuit

52 scan pulse output circuit

53 switch controller

55 auxiliary power supply

60 voltage setting circuit

70 sustain pulse generator

80 initializing waveform generator

100 plasma display device

OUT1-OUTn switch

Q61, Q71, Q72, Q73, Q83 switching element

QL1-QLn switching element (first switching element)

QH1-QHn switching element (second switching element)

Vfl reference potential

### DETAILED DESCRIPTION OF THE PREFERRED EMBODIMENTS

The plasma display device of an exemplary embodiment of the present invention is described hereinafter with reference to the accompanying drawings.

### Exemplary Embodiment

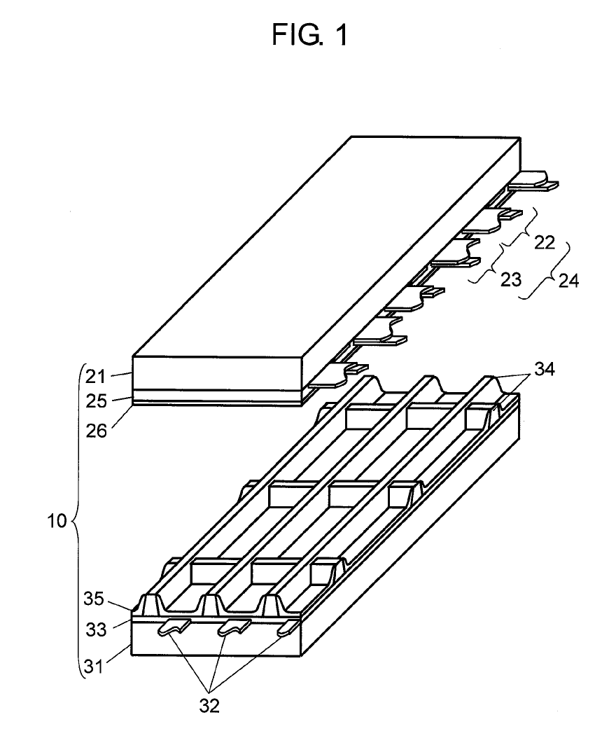

FIG. 1 is an exploded perspective view showing the structure of panel 10 in accordance with an exemplary embodiment of the present invention. On glass-made front substrate 21, display electrodes 24 formed as a pair of scan electrodes 22 and sustain electrodes 23 are arranged, and over which, dielectric layer 25 and protective layer 26 are formed to cover display electrodes 24. On rear substrate 31, data electrodes 32 are disposed, and over which, dielectric layer 33 is formed to cover data electrodes 32. On dielectric layer 33, barrier ribs 34 are formed in a mesh arrangement. Phosphor layer 35, which is responsible for emitting light in red, green and blue, is formed on dielectric layer 33 and on the side surfaces of barrier ribs 34.

Front substrate 21 and rear substrate 31 are oppositely disposed in a manner that display electrodes 24 are placed orthogonal to data electrodes 32 in a small discharge space between the two substrates. The two substrates are sealed at the peripheries with a sealing material such as glass frit. The discharge space is filled with discharge gas, for example, a gas including xenon with a partial pressure of 10%. The discharge space is divided into sections by barrier ribs 34. Discharge cells are formed at intersections of display electrodes 24 and data electrodes 32. Generating discharge allows a discharge cell to emit light, so that an image appears.

Panel 10 does not necessarily have the structure above, and the barrier ribs may be formed in stripes.

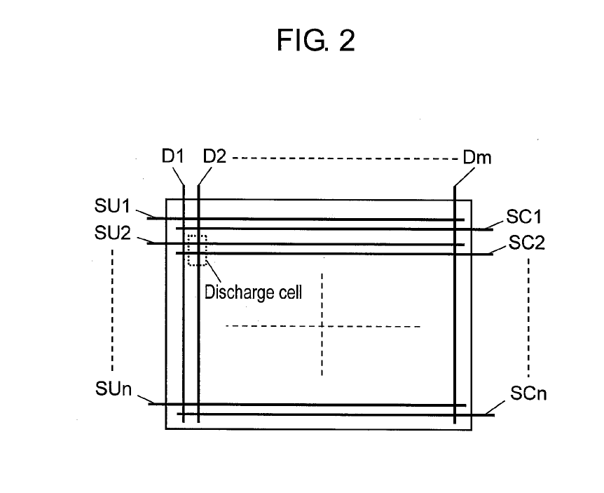

FIG. 2 shows an electrode layout of panel 10 in accordance with the embodiment. In the horizontal direction, panel 10 has n long scan electrodes SC1-SCn (corresponding to scan electrodes 22 in FIG. 1) and n long sustain electrodes SU1-SUn (corresponding to sustain electrodes 23 in FIG. 1). In the vertical direction, panel 10 has m long data electrodes D1-Dm (corresponding to data electrodes 32 in FIG. 1). A discharge cell is formed at an intersection of a pair of scan electrode SCi and sustain electrode SUi (where, i takes 1 to n) and data electrode Dj (where, j takes 1 to m). That is, panel 10 contains m×n discharge cells in the discharge space. As shown in FIGS. 1 and 2, scan electrode SCi is disposed parallel to sustain electrode Sui, and the arrangement forms a large inter-electrode capacity Cp between scan electrodes SC1-SCn and sustain electrodes SU1-SUn.

Next will be described the structure and workings of the plasma display device of the embodiment.

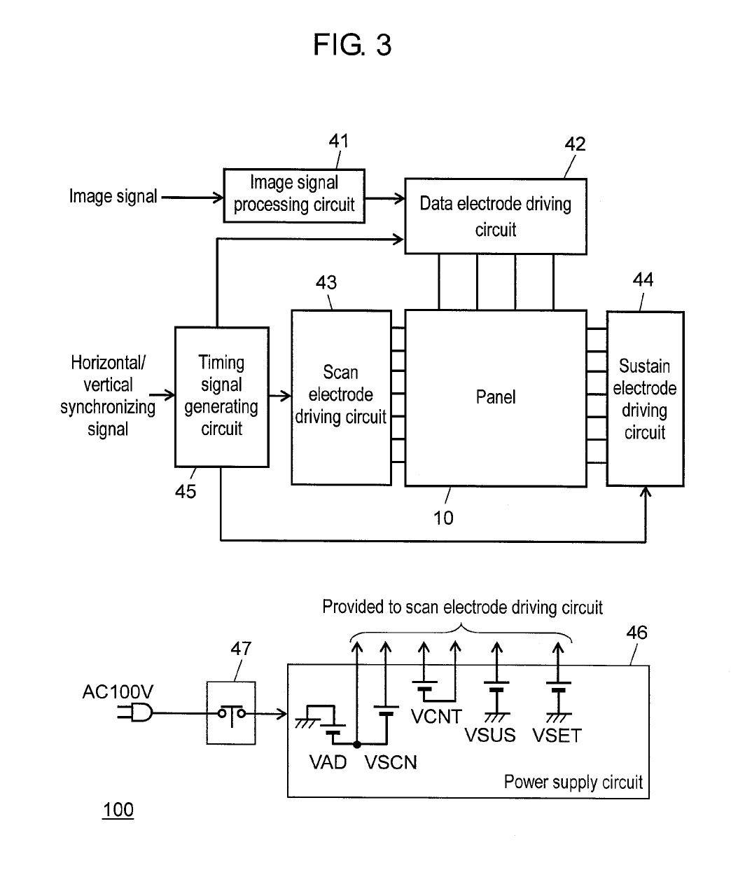

FIG. 3 is a circuit block diagram of plasma display device 100 of the embodiment. Plasma display device 100 has panel 10, image signal processing circuit 41, data electrode driving circuit 42, scan electrode driving circuit 43, sustain electrode driving circuit 44, timing signal generating circuit 45, power supply circuit 46 and power switch 47. Power supply circuit 46 delivers it to each circuit block. Power switch 47 supplies power supply circuit 46 with power from a commercial power supply (100V AC).

Image signal processing circuit 41 converts an image signal into data having pixels and gradation suitable for panel 10, and further converts the data into image data for light-emitting corresponding to ‘1’ as a digital signal or non-light-emitting corresponding to ‘0’ as a digital signal on a subfield basis. Data electrode driving circuit 42 converts the image data of each subfield into address pulses suitable for data electrodes D1-Dm to drive them.

Timing signal generating circuit 45 generates timing signals that control each circuit block according to a horizontal synchronizing signal and a vertical synchronizing signal, and the timing signals are fed to each circuit block. Receiving the timing signals, scan electrode driving circuit 43 and sustain electrode driving circuit 44 generate waveforms of driving voltage and apply them to scan electrodes SC1-SCn and sustain electrodes SU1-SUn, respectively.

Power supply circuit 46 has various power supplies for providing each circuit block. For example, the following are provided for scan electrode driving circuit 43: power supplies VSUS, VSET, VAD, VSCN, and controller-dedicated power supply VCNT. Power supply VSUS generates positive sustain pulse voltage Vsus. Power supply VSET generates positive voltage Vset. Power supply VAD generates negative voltage Vad. Power supply VSCN generates voltage by adding voltage Vscn on the voltage provided by power supply VAD. Controller-dedicated power supply VCNT generates a voltage in which a voltage of 15V is added on a predetermined reference voltage.

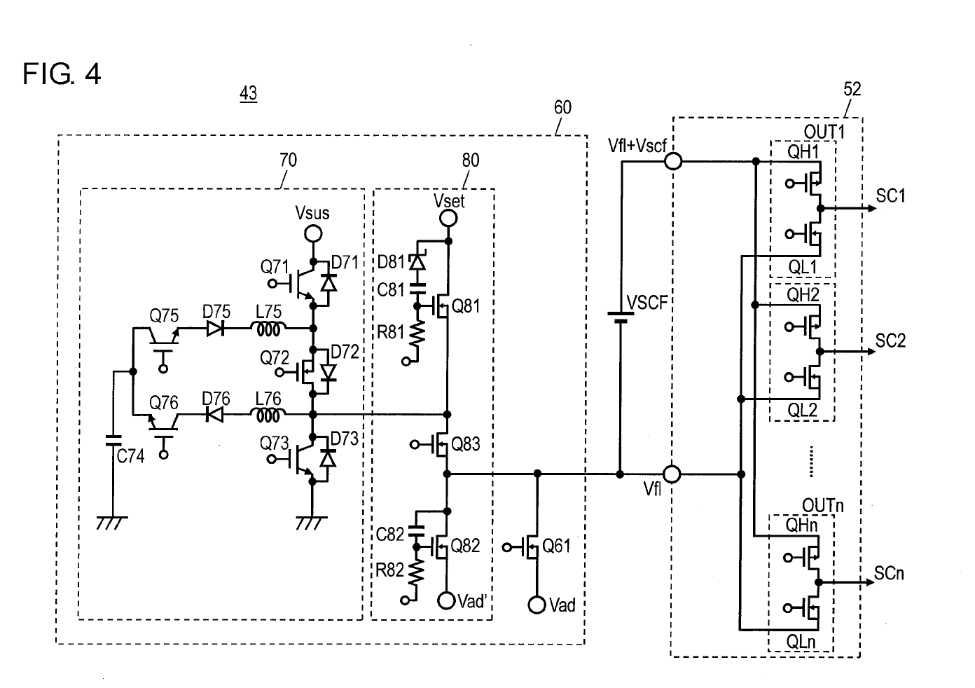

FIG. 4 is a circuit diagram showing a detailed structure of scan electrode driving circuit 43 of the embodiment. Scan electrode driving circuit 43 has scan pulse output circuit 52, power supply VSCF and voltage-setting circuit 60. Scan pulse output circuit 52 is a driving-waveform generator that outputs scan pulses. Electrode-dedicated power supply VSCF generates voltage Vscf to be applied to the electrodes. Voltage Vscf is added on reference potential Vfl of scan pulse output circuit 52. Voltage-setting circuit 60 determines reference potential Vfl of scan pulse output circuit 52 to be a predetermined voltage (will be described later).

Scan pulse output circuit 52 has switches OUT1-OUTn for applying scan-pulse voltage to scan electrodes OUT1-OUTn, respectively. Each of switches OUT1-OUTn has switching elements QL1-QLn as first switching elements and switching elements QH1-QHn as second switching elements. Switching elements QL1-QLn, as first switching elements, output reference potential Vfl, i.e., the lower-side voltage of electrode-dedicated power supply VSCF. On the other hand, switching elements QH1-QHn, as second switching elements, output voltage Vscf, i.e., the higher-side voltage of power supply VSCF, which is added on reference potential Vfl.

Voltage-setting circuit 60 has switching element Q61, sustain pulse generator 70 and initializing waveform generator 80. Switching element 61 is an element to clamps reference potential Vfl of scan pulse generating circuit 50 to negative voltage Vad. Sustain pulse generator 70 generates sustain pulses. Initializing waveform generator 80 generates voltage with a ramp waveform.

Sustain pulse generator 70 has switching elements Q71-Q73 and diodes D71-D73. Switching elements Q71 and Q72 are elements to clamp the voltage of a scan electrode to sustain pulse voltage Vsus, while switching element Q73 is an element to clamp the voltage of a scan electrode to 0V. Diodes D71-D73 are connected in parallel to switching elements Q71-Q73, respectively. In addition to the components above, sustain pulse generator 70 has capacitor C74 for recovering power, switching elements Q75 and Q76, diodes D75 and D76 for preventing reverse flow and resonance inductors L75 and L76. Having a capacitance sufficiently larger than that of inter-electrode capacity Cp, capacitor C74 has been half-charged of sustain pulse voltage Vsus.

Initializing waveform generator 80 has two Miller integrator circuits and a separator circuit. Of the two Miller integrator circuits, one has a field-effect transistor Q81, capacitor C81, resistor R81 and Zener diode D81 and connected to power supply of voltage Vset; the other has an FET Q82, capacitor C82, resistor R82 and connected to voltage Vad′.

Voltage-setting circuit 60 with the structure above allows reference potential Vfl of scan pulse output circuit 52 to be clamped to negative voltage Vad, 0V and other desired values.

While panel 10 is operating, switching elements Q75, Q76, Q71, Q73, Q83, Q61 and diodes D75, D76, D72 undergo a significantly large peak current. FIG. 4 shows each of the aforementioned devices as a single symbol for sake of clarity; each of these switching elements and diodes is usually formed of several to tens of identically structured devices connected in parallel so as to have lowered impedance.

Next will be described the driving method of panel 10. Panel 10 employs a subfield method to provide gradation display. In the subfield method, one TV field is divided into a plurality of subfields. Light-emitting control of the discharge cells is carried out on a subfield basis. Each subfield has the initializing period, the address period and the sustain period.

In the initializing period, an initializing discharge is generated to form wall charges on each electrode as a preparation for an address discharge that follows the initializing discharge. In the initializing period, two types of reset operations are selectively carried out: an all-cell reset operation in which the initializing discharge occurs in all of the cells; and a selective-cell reset operation in which the initializing discharge occurs in a cell where a sustain discharge occurred in the previous sustain period. In the address period, scan pulses as address voltage are applied to the scan electrodes; at the same time, address pulses are selectively applied to the data electrodes, which selectively causes an address discharge in a discharge cell to be lit and forms wall charges. In the sustain period, sustain pulses are alternately applied to the display electrodes so that a sustain discharge occurs in the discharge cell in which an address discharge occurred. The number of the sustain pulses applied alternately to the display electrodes corresponds to a luminance weight for light emitting. In this way, the discharge cells where the address discharge occurred emit light.

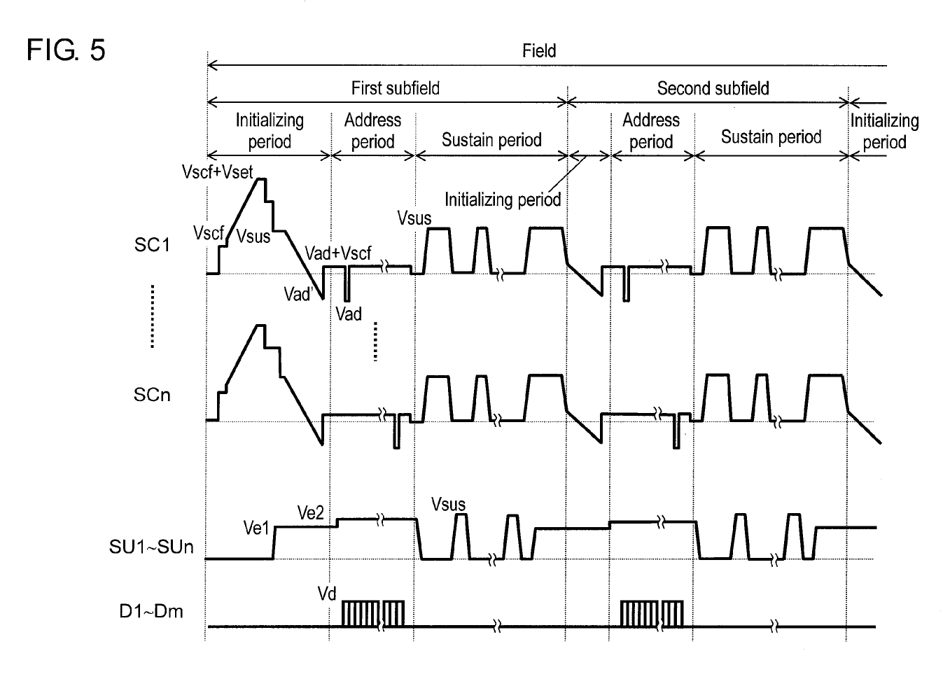

FIG. 5 shows waveforms of driving voltage to be applied to each electrode on the assumption that the first subfield is responsible for all-cell reset operation and the second subfield is responsible for selective-cell reset operation. As described above, one TV field is formed of a plurality of subfields including the first subfield and the second subfield.

In the first half of the initializing period of the first subfield, voltage of zero (0V) is applied to data electrodes D1-Dm and sustain electrodes SU1-SUn. Besides, switching elements Q73 and Q83 are turned on, and reference potential Vfl is set to 0V. Switching elements QH1-QHn of switches OUT1-OUTn are turned on, and voltage Vscf is applied to scan electrodes SC1-SCn. Next, switching element Q73 is turned off; and at the same time, FET Q81 is turned on. By the switching operation, the Miller integrator circuits works. As the Miller integrator circuits start working, reference potential Vfl varies; after having increase by Zener voltage Vz of Zener diode D81, reference potential Vfl now a gentle increase toward the level of voltage Vset. In this way, a voltage with a ramp waveform, which exhibits a gentle increase to the level corresponding to voltage Vset+Vscf, is applied to scan electrodes SC1-SCn. During the application of voltage with a mildly increasing waveform, weak initializing discharge occurs between scan electrodes SC1-SCn, sustain electrodes SU1-SUn and data electrodes D1-Dm, respectively. The wall voltage is accumulated on each electrode. The wall voltage on each electrode represents a voltage generated by wall charges accumulated on the dielectric layer, the protective layer and the phosphor layer on the electrodes.

In the latter half of the initializing period, positive voltage Ve1 is applied to sustain electrodes SU1-SUn. FET Q81 is turned off and switching elements Q71 and Q72 are turned on. The switching operation allows reference potential Vfl to set to voltage Vsus, so that voltage Vsus+Vscf is applied to scan electrodes SC1-SCn. Next, in switches OUT1-OUTn, switching elements QH1-QHn are turned off; while QL1-QLn are turned on. Through the switching operation, voltage Vsus is applied to scan electrodes SC1-SCn. The on/off switching above is not carried out simultaneously but in two steps; after half the elements are switched, the rest half follows with a lag. After that, switching element Q83 is turned off and FET Q82 is turned on. The switching operation drives the Miller integrator circuits. As the Miller integrator circuits start working, reference potential Vfl mildly decreases toward voltage Vad′. In this way, a voltage with a ramp waveform, which exhibits a mild decrease to the level corresponding to voltage Vad′, is applied to scan electrodes SC1-SCn. During the application of voltage with a mildly decreasing waveform, a weak initializing discharge occurs again between the electrodes. Through the initializing discharge, wall voltage accumulated on each electrode is adjusted to a value suitable for address operations. In the initializing period of the first subfield, the all-cell reset operation-in which the initializing discharge occurs in all the discharge cells-is carried out.

In the address period, voltage Ve2 is applied to sustain electrodes SU1-SUn. Turning on switching element Q61 allows reference potential Vfl to be set to negative voltage Vad, and at the same time, turning on switching elements QH1-QHn causes voltage output of the electrode-dedicated power supply. Through the switching operation above, voltage Vad+Vscf is applied to scan electrodes SC1-SCn.

Next, switching element QH1 is turned off and switching element QL1 is turned on. Through the switching operation, negative scan-pulse voltage Vad is applied to scan electrode SC1 located at the first row, and positive address-pulse voltage Vd is applied to data electrode Dk (k takes 1 to m), which corresponds to the discharge cell to be lit at the first row, in data electrodes D1-Dm. Of the discharge cells located at the first row, a discharge cell that had the application of address-pulse voltage undergoes an address discharge, which causes the address operation in which wall voltage is accumulated on each electrode. On the other hand, a discharge cell with no application of address-pulse voltage Vd has no address discharge. That is, the address operation is selectively carried out. After that, switching element QH1 is turned on, while switching element QL1 is turned off.

Then, switching element QH2 is turned off and switching element QL2 is turned on. Through the switching operation, scan-pulse voltage Vad is applied to scan electrode SC2 located at the second row, and address-pulse voltage Vd is applied to data electrode Dk, which corresponds to the discharge cell to be lit at the second row, in data electrodes D1-Dm. Then, at discharge cells in the second row, the address operation is selectively carried out in the discharge cells at the second row. In this way, the address operation is repeatedly carried out until the discharge cells located in the n^{th} row.

After that, switching elements QH1-QHn and QL1-QLn of switches OUT1-OUTn are turned off. The switching operation brings the output of switches OUT1-OUTn into a high-impedance state. And in the meantime, switching element Q61 is turned off and switching elements Q83 and Q73 are turned on, so that reference potential Vfl is clamped to 0V. After that, switching elements QL1-QLn of switches OUT1-OUTn are turned on, by which voltage of zero (0V) is applied to scan electrodes SC1-SCn.

In the following sustain period, voltage of zero (0V) is applied to sustain electrodes SU1-SUn, and at the same time, sustain pulse voltage Vsus is applied to scan electrodes SC1-SCn. For the application of sustain pulse voltage Vsus, switching element Q73 is turned off and switching elements Q75, Q72, Q83 are turned on. The switching operation allows current to start flowing from capacitor C74 as a power recovery via switching element Q75, diode D75, inductor L75, switching element Q72 (or diode D72), switching element Q83, and switching elements QL1-QLn. As the current flows, each voltage of scan electrodes SC1-SCn starts to increase. Inductor L75 and inter-electrode capacity Cp form a resonance circuit, and the voltage of scan-electrodes SC1-SCn almost reaches voltage Vsus after a lapse of half the resonance period. Scan electrodes SC1-SCn are connected to power supply via switching element Q71. Therefore, turning on switching element Q71 inevitably raise each voltage of scan electrodes SC1-SCn up to voltage Vsus. Under the state, a sustain discharge occurs in the discharge cell where an address discharge occurred in the previous period.

Next, voltage of zero (0V) is applied to scan electrodes SC1-SCn and sustain pulse voltage Vsus is applied to sustain electrodes SU1-SUn. For the application of voltage of zero (0V), switching elements Q76 and Q83 are turned on. The switching operation allows current to start flowing from scan electrodes SC1-SCn through switching elements QL1-QLn, switching element Q83, inductor L76, diode D76 and switching element Q76 to capacitor C74 as a power recovery. As the current flows, each voltage of scan electrodes SC1-SCn starts to decrease. As inductor L76 and inter-electrode capacity Cp form a resonance circuit, the voltage of scan-electrodes SC1-SCn almost reaches 0V after a lapse of half the resonance period. And switching element Q73 is turned on. Scan electrodes SC1-SCn are connected to ground potential via switching element Q73. Therefore, each voltage of scan electrodes SC1-SCn decreases down to 0V. Under the state, sustain pulse voltage Vsus is applied to sustain electrodes SU1-SUn. As a result, a sustain discharge occurs again in the discharge cell that has experienced a sustain discharge before.

In this way, scan electrodes SC1-SCn and sustain electrodes SU1-SUn alternately undergo sustain pulses, where the number of the pulses to be applied are determined by a luminance weight. By providing difference in voltage between the electrodes as each pair of the display electrodes, the sustain discharge to repeatedly occur in a discharge cell where an address discharge occurred in the address period.

In the initializing period of the second subfield, the operation similar to that described in the latter half of the initializing period of the first subfield is carried out. That is, positive voltage Ve1 is applied to sustain electrodes SU1-SUn; on the other hand, a voltage with a ramp waveform, which exhibits a mild decrease to voltage Vad′, is applied to scan electrodes SC1-SCn. The initializing period of the second sub-filed is responsible for the selective-cell reset operation in which an initializing discharge occurs in a cell where a sustain discharge occurred in the previous sustain period.

The following address period and the sustain period have operations similar to those of the first subfield and descriptions thereof will be omitted. The operations are similarly carried out in the rest of the subfield except for the number of sustain pulses.

The structure of the embodiment employs the following setting values of each voltage: 330V for voltage Vset; 190V for voltage Vsus; 140V for voltage Vscf;—100V for voltage Vad; 160V for voltage Ve1; and 170V for voltage Ve2. These values are just an example; they should be determined to have optimum values according to the characteristics of panel 10 and specifications of plasma display device 100.

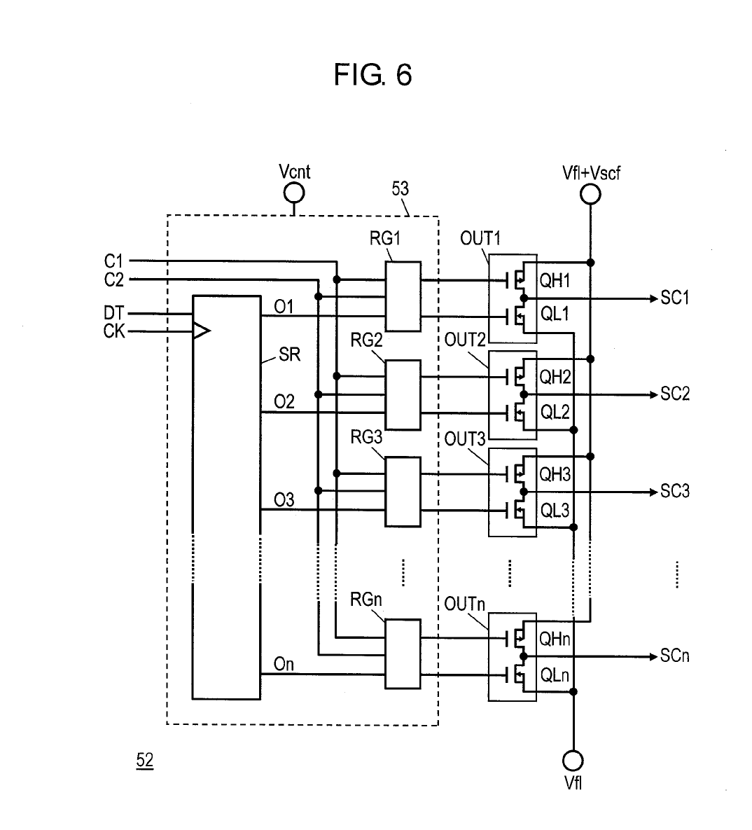

FIG. 6 shows a detailed circuit block diagram of scan pulse output circuit 52 of the embodiment. In addition to switches OUT1-OUTn for providing scan-pulse voltage, scan pulse output circuit 52 has switch controller 53. Switch controller 53 controls switching elements QH1-QHn and QL1-QLn of switches OUT1-OUTn. Switch controller 53 has output controllers RG1-RGn and shift resister SR. Shift resister SR sends binary signals having different phases to output controllers RG1-RGn.

Receiving data DT and clock CK, shift resister SR sequentially reads data DT and shifts to the next one at each input of clock CK, and outputs n outputs O1-On. In the address period, shift resister SR receives one pulse from data DT and shifts the pulse so as to output n binary data with different phases, which are to be finally formed into a scan pulse, to output controllers RG1-RGn.

Receiving control signals C1, C2 and outputs O1-On, each of output controllers RG1-RGn controls switching elements QH1-QHn and QL1-QLn of switches OUT1-OUTn, respectively.

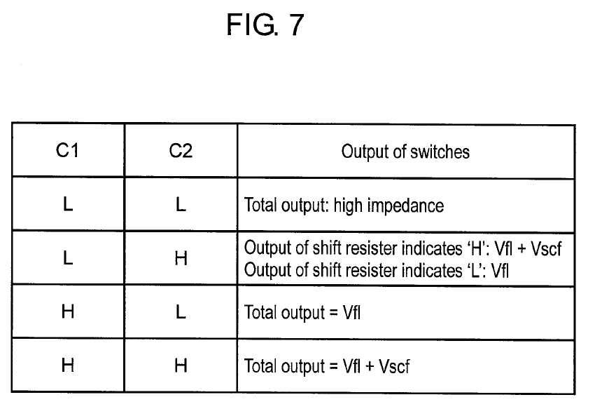

FIG. 7 shows control operations of output controllers RG1-RGn of the embodiment. According to control signals C1 and C2, output controllers RG1-RGn determine each output of switches OUT1-OUTn as follows:
Under the state where both of C1 and C2 are ‘L’, switching elements QHi and QLi are turned off; each output of switching elements QHi and QLi becomes to be in a high-impedance state.
Under the state where C1 is ‘L’ and C2 is ‘H’, the on/off state of switching elements QHi and QLi depends on the output of the corresponding shift resister SR. According to the embodiment, when output Oi of shift resister SR is ‘H’, switching element QHi is turned on and switching element QLi is turned off. On the other hand, when output Oi of shift resister SR is ‘L’, switching element QHi is turned off and switching element QLi is turned on.
Under the state where C1 is ‘H’ and C2 is ‘L’, switching element QHi is turned off and switching element QLi is turned on with no regard to output Oi of shift resister SR. That is, outputs reference potential Vfl is output.
Under the state where both of C1 and C2 are ‘H’, switching element QHi is turned on and switching element QLi is turned off with no regard to output Oi of shift resister SR. That is, voltage Vscf that is added on reference potential Vfl is output.

In scan pulse output circuit 52, plurality of switches OUT1-OUTn, plurality of output controllers RG1-RGn and shift resister SR are formed into a single package as an integrated circuit. Hereinafter, the integrated circuit is referred to as a scan-IC. The structure of the embodiment employs 12 scan-ICs each of which contains 64 scan electrodes, and scan pulses are applied to scan electrodes SC1-SCn (n=12×64=768). Forming scan pulse output circuit 52 having a plurality of outputs as an IC allows the entire circuit to be compact, reducing the mounting area of the circuit.

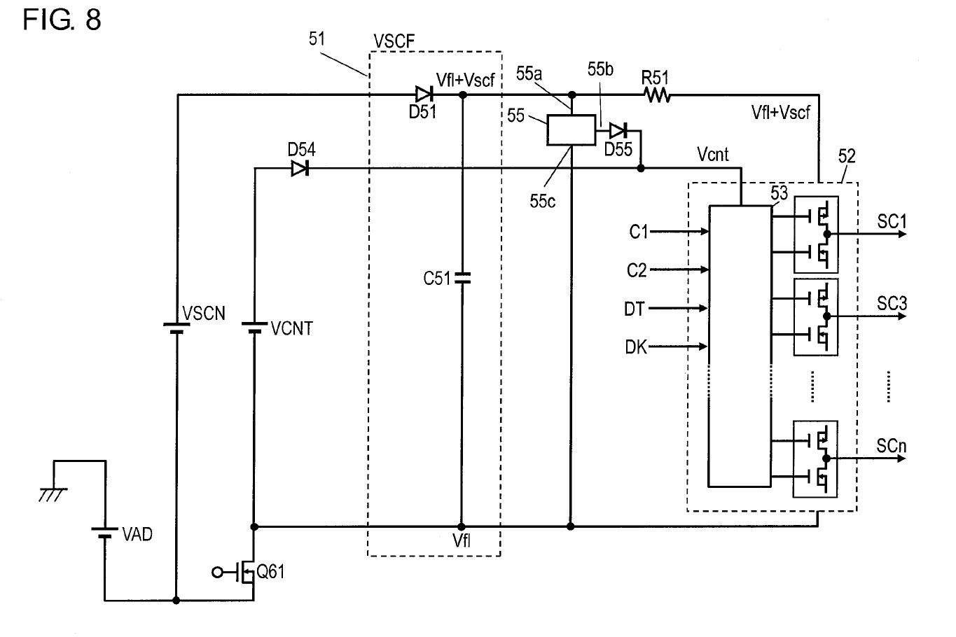

FIG. 8 is a circuit diagram including scan pulse output circuit 52 and the power supply for supplying power to the circuit of the embodiment. The lower-voltage side of scan pulse output circuit 52 is connected to reference potential Vfl, while the higher-voltage side of the circuit is connected, via resistor R51, to power supply VSCF for electrodes. Voltage of the power supply VSCF is voltage adding voltage Vscf on reference potential Vfl. Power supply VSCF for applying voltage to the electrodes can be formed of various structures. In the embodiment, it is formed of Bootstrap circuit 51. Bootstrap circuit 51 of the embodiment has diode D51 and capacitor C51. With the structure above, bootstrap circuit 51 serves as electrode-dedicated power supply VSCF by adding the voltage of power supply VSCN that is added on negative voltage Vad of power supply VAD onto reference potential Vfl.

Switch controller 53 receives a voltage of 15V from controller-dedicated power supply VCNT, which may be formed of a DC/DC converter, via diode D54 for preventing reverse flow of current. The structure of the embodiment further has auxiliary power supply 55 and diode D55 for preventing reverse flow of current.

Auxiliary power supply 55 steps down voltage Vscf of power supply VSCF so as to have a voltage lower than 15V (12V, for example) and supplies switch controller 53 with electric power. Auxiliary power supply 55 has terminals 55a, 55b and 55c. Terminal 55a is disposed at the connection point of diode D51, capacitor C51 and resistor R51. Terminal 55b is connected to diode D55 for preventing reverse flow of current. Terminal 55c is disposed at the connection point of switching element Q61, power supply VCNT, capacitor C51 and scan pulse output circuit 52.

Receiving control signals C1, C2, data DT and clock CK, scan pulse output circuit 52 drives scan electrodes SC1-SCn.

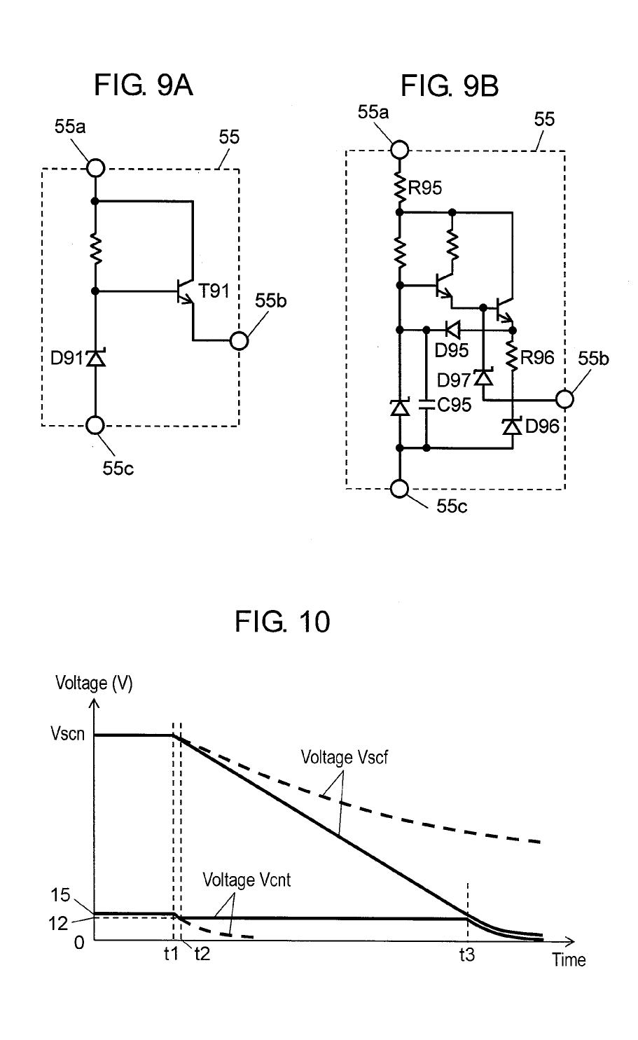

Each of FIGS. 9A and 9B shows an example of auxiliary power supply 55 of the embodiment. An ordinary VAC circuit can be employed for auxiliary power supply 55. Having the simplest structure, auxiliary power supply 55 of FIG. 9A outputs a voltage stepped down from Zener voltage of Zener diode D91 by the base-emitter voltage of transistor T91. Terminals 55a, 55b, 55c of FIG. 9A correspond to those of FIG. 8, respectively. FIG. 9B is a circuit diagram showing another example of auxiliary power supply 55 having the following as additional components: diode D95 for protecting the transistor from reverse current beyond reverse breakdown voltage, Zener diode D96 for preventing an excessive output voltage, capacitor C95 for eliminating noise, and resistor R95 for protecting the circuit from over current. The structure of FIG. 9B further contains a Darlington pair, resistor R96 and Zener diode D97. The configuration is effective in achieving a high current gain by using the Darlington pair, and in limiting current by using resistor R96 and Zener diode D97. Terminals 55a, 55b and 55c of FIG. 9B correspond to those of FIG. 8, respectively.

As is described above, when plasma display device 100 is in normal operation, reference potential Vfl is set to voltage Vad in the address period, by which current flows from power supply VSCN to capacitor C51 via diode D51, so that capacitor C51 is charged. Capacitor C51 serves as power supply VSCF that provides the electrodes with voltage added on reference potential Vfl. The voltage of power supply VCNT, which is applied to switch controller 53, is higher than the output voltage of auxiliary power supply 55. Therefore, diode D55 for preventing reverse-flow is turned off and no current is fed from auxiliary power supply 55 to switch controller 53. Auxiliary power supply 55 allows scan pulse output circuit 52 to complete image display operation with no abnormal condition when power switch 47 of plasma display device 100 is turned off.

FIG. 10 illustrates the workings of auxiliary power supply 55 of the embodiment, showing time on the horizontal axis and voltage on the vertical axis. When power switch 47 of plasma display device 100 is turned off at time t1, each voltage fed from power supply circuit 46 starts to decrease; voltage Vscf of electrode-dedicated power supply VSCF and voltage Vcnt of controller-dedicated power supply VCNT start to decrease. As is apparent from the graph, voltage Vcnt has a relatively fast decrease, whereas voltage Vscf has a slow decrease because capacitor C51 of bootstrap circuit 51, which serves as power supply VSCF, has a relatively large capacitance.

The dotted lines of FIG. 10 show the decrease of each voltage if auxiliary power supply 55 is not disposed in the structure. Voltage Vcnt of controller-dedicated power supply VCNT decreases before that voltage Vscf of electrode-dedicated power supply VSCF decreases. In case that voltage Vcnt of controller-dedicated power supply VCNT decreases to equal or less than a certain voltage, control of switching elements QH1-QHn and QL1-QLn becomes to be unstable. Under the condition, if switching elements QHi and QLi turn on at the same time, an excessive current flows in elements QHi and QLi, may resulting in damage to a scan-IC.

The structure of the embodiment addresses the problem above. When voltage Vcnt of power supply VCNT goes down below 12V (i.e., the output voltage of auxiliary power supply 55) between time t2 and time t3, auxiliary power supply 55 starts working. As voltage Vcnt fed from power supply VCNT gets lower than the output voltage of auxiliary power supply 55, diode D55 for preventing reverse-flow turns on, so that a voltage of 12V stepped down from voltage Vscf of power supply VSCF is applied to switch controller 53. In this way, even after voltage Vcnt of power supply VCNT has decreased, a voltage of 12V is continuously fed from auxiliary power supply 55. This maintains stable control of switching elements QH1-QHn and QL1-QLn. When voltage Vscf of bootstrap circuit 51 goes down below 12V in some time after time t3, switch control of elements QH1-QHn and QL1-QLn can lose its stability. However, at this time, as voltage of bootstrap circuit 55 is a sufficiently lowered, there is no worry about an excessive current-flow even if switching elements QHi and QLi turn on at the same time.

The description has been given so far on a case where the scan pulse output circuit serves as a driving waveform generator; voltage supply VSCF serves as an electrode-dedicated power supply for providing electrodes with a voltage added on reference potential Vfl; and power supply VCNT serves as a controller-dedicated power supply for providing the reference potential with a voltage of 15V The structure above is introduced merely as an example. And the present invention is not limited above. For example, switching element Q61 responsible for fixing reference potential Vfl to voltage Vad can be the driving waveform generator and power supply VAD or power supply VSCN can be the power supply for providing electrodes with voltage. With the structure above, the auxiliary power supply can be formed similarly.

The voltage values in the description above are cited merely by way of example, they should preferably be determined to have optimum values according to the characteristics of a panel and specifications of a plasma display device.

The structure of the present invention, as described above, provides a plasma display device capable of completing the operations of the panel-driving circuit with no abnormal condition when the power switch is turned off. Besides, the aforementioned advantage can be obtained without substantial changes to its design.

### INDUSTRIAL APPLICABILITY

The present invention is useful in providing a plasma display device capable of completing the operations of the panel-driving circuit with no abnormal condition when the power switch is turned off. Besides, the aforementioned advantage can be obtained without substantial changes to its design.

What is claimed is:

1. A plasma display device comprising:
a plasma display panel having a plurality of discharge cells, each of the discharge cells being formed of at least a scan electrode, a sustain electrode and a data electrode;
an electrode-dedicated power supply for generating voltage to be applied to any one of the scan electrode, the sustain electrode and the data electrode;
a driving-waveform generator that has a switching element for outputting voltage of the electrode-dedicated power supply and generates a waveform of driving voltage for driving the electrodes;
a switch controller for controlling the switching element;
a controller-dedicated power supply for supplying the switch controller with electric power; and
an auxiliary power supply that generates a voltage lower than that of the controller-dedicated power supply by reducing voltage of the electrode-dedicated power supply and supplies the switch controller with electric power.

2. The plasma display device of claim 1, wherein the driving-waveform generator has a plurality of switches, each of the switches including a first switching element for outputting voltage of a lower voltage side of the electrode-dedicated power supply and a second switching element for outputting voltage of a higher voltage side of the electrode-dedicated power supply, the driving-waveform generator serves as a scan pulse output circuit for outputting a scan pulse to be applied to each of the scan electrodes.
